(19) United States
(12) Patent Application Publication
(10) Pub. No.: US 2004/0097615 A1
(43) Pub. Date: May 20, 2004

(54) Ink composition for ink jet printing

(75) Inventors: Richard C. Reem, Hilton, NY (US); Karen J. Klingman, Pittsford, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/299,385

(22) Filed: Nov. 19, 2002

(51) Int. Cl. C03C 17/00; C09D 5/00

(52) U.S. Cl. 523/160; 523/161

(57) ABSTRACT

Cyan, magenta and yellow pigment-based ink compositions for ink jet printing are described; wherein the ink compositions each comprise a pigment, water, water miscible humectants and/or water-miscible organic co-solvents, surfactants, or mixtures thereof; wherein the normalized differential specular reflectance, NΔR_{S}(X), for the cyan, magenta and yellow inks is less than 1.25, 0.50 and 0.30, respectively. NΔR_{S}(X) is defined as the maximum value within a set of NΔR_{S}(Xn) values in which each NΔR_{S}(Xn) is the normalized specular reflectance for a density patch of a printed test image. The printed test image consists of a series of at least ten density patches printed such that the ink laydown on the patches increases incrementally, from no ink laydown to a maximum level generating a density of at least 1.5; and wherein NΔR_{S}(Xn) for each patch is determined according to:

$$N Δ {R}_{S} ( X n ) = \frac{[ {R}_{S max} ( X n ) - {R}_{S min} ( X n ) ]}{{R}_{S mean} ( X n )}$$

where, over the visible spectral region between 390 nm and 720 nm for patch Xn, R_{Smax}(Xn) is the maximum, R_{Smin}(Xn) is the minimum, and R_{Smean}(Xn) is the average specular reflectance.

### CROSS REFERENCE TO RELATED APPLICATIONS

Reference is made to commonly assigned, co-pending application Ser. No. ______ by Reem and Klingman, (Docket 84671) filed of even date herewith entitled “Ink Set for Ink Jet Printing”; and application Ser. No. ______ by Reem and Klingman, (Docket 84673) filed of even date herewith entitled “Combination Ink Set/Image-Recording Element for Ink Jet Printing.” These applications are incorporated by reference herein for all that they contain.

### FIELD OF THE INVENTION

This invention relates to a pigment-based ink composition for ink jet printing that exhibits minimal, if any, chromatic gloss when printed on an image-recording element.

### BACKGROUND OF THE INVENTION

Ink jet printing is a non-impact method for producing images by the deposition of ink droplets in a pixel-by-pixel manner to an image-recording element in response to digital signals. There are various methods that may be utilized to control the deposition of ink droplets on the image-recording element to yield the desired printed image. In one process, known as continuous ink jet, a continuous stream of droplets is charged and deflected in an imagewise manner onto the surface of the image-recording element, while unimaged droplets are caught and returned to an ink sump. In another process, known as drop-on-demand ink jet, individual ink droplets are projected as needed onto the image-recording element to form the desired printed image. Common methods of controlling the projection of ink droplets in drop-on-demand printing include piezoelectric transducers and thermal bubble formation. Ink jet printers have found broad applications across markets ranging from industrial labeling to short run printing to desktop document and pictorial imaging.

The inks used in the various ink jet printers can be classified as either pigment-based or dye-based. A pigment is a colorant that is insoluble in the carrier medium, but is dispersed or suspended in the form of small particles, often stabilized against flocculation and settling by the use of dispersing agents. A dye is a colorant that is dissolved in the carrier medium. In either case, the carrier medium can be a liquid or a solid at room temperature. Commonly used carrier media are aqueous-based and include water, water miscible humectants and water miscible organic co-solvents.

Pigment-based inks are often preferred over dye-based inks because they render printed images having higher optical densities and better resistance to light and ozone as compared to printed images made with dye-based inks. However, pigment-based inks have their own set of deficiencies that tends to arise from the propensity of the pigment particles to accumulate at the surface of the image-recording element. For example, the pigment particles may exhibit poor rub resistance or cause variations in gloss between imaged areas of different colors in a printed image. Solutions to these problems have been discussed extensively in the patent literature, see for example U.S. Pat. Nos. 6,161,929 and 5,925,178; Eur. Pat. Appl. No. EP 1 108 760 A1; and U.S. patent application Ser. Nos. 10/032,931; 10/033,229; 10/034,281 and 10/034,285 filed on Dec. 28, 2001, the disclosures of which are incorporated herein by reference.

Another deficiency with pigment-based inks is that they may give rise to chromatic gloss in certain imaged areas in a printed image. Chromatic gloss is an artifact that appears as a colored sheen or gloss from the surface of a printed image as the view and/or illumination angle changes relative to the surface of the printed image. In printed images prepared using ink jet inks and image-recording elements, chromatic gloss typically appears as a pink sheen in cyan-colored imaged areas, a yellow-orange sheen in magenta-colored imaged areas and a blue sheen in yellow-colored imaged areas. Chromatic gloss is especially problematic when pigment-based inks are printed on glossy image-recording elements. Although chromatic gloss has been observed for commercially available pigment-based ink sets printed on image-recording elements as will be shown herein, no discussion or acknowledgment of chromatic gloss in ink jet printing has been found in the literature.

Another, similar artifact called bronzing has been described in the field of graphic arts printing, and is sometimes visible for ink jet printed images as well. Although bronzing can appear in samples from the same printer system as chromatic gloss, bronzing appears as a metallic, bronze-colored sheen, and is different than chromatic gloss. This invention pertains to chromatic gloss.

Although not designed to minimize chromatic gloss, one possible solution to this problem is to laminate the entire printed image with a protective layer. Another possible solution is to print on an image-recording element having a fusible top layer into which the ink components can penetrate, and then fuse the top layer to generate a smooth glossy surface. Examples of such technology are disclosed in U.S. patent application Ser. No. 09/954,779, filed on Sep. 18, 2001 of Wexler, or coating a protective layer on the imaged areas as described in EP 1 0576 46 A1 and EP 1 048 466 A1. However, all these approaches involve separate steps after printing, making the entire process complex and costly.

For the production of high quality photorealistic images via ink jet printing, pigment-based inks must provide printed images that are free from objectionable chromatic gloss. It is an object of this invention to provide a pigment-based ink composition for ink jet printing that, when printed on an image-recording element, minimizes chromatic gloss to an acceptable level without requiring a separate step after printing.

### SUMMARY OF THE INVENTION

The present invention overcomes the problems discussed above by providing cyan, magenta and yellow pigment-based ink compositions for ink jet printing; wherein the ink compositions each comprise a pigment, water, water miscible humectants and/or water-miscible organic co-solvents, surfactants, or mixtures thereof, wherein the cyan ink composition has a normalized differential specular reflectance, NΔR_{S}(C), of less than 1.25; wherein the magenta ink composition has a normalized differential specular reflectance, NΔR_{S}(M), of less than 0.50; and wherein the yellow ink composition has a normalized differential specular reflectance, NΔR_{S}(Y), of less than 0.30 when calculated according to Equation 1:

NΔR_{S}(X)=[NΔR_{S}(Xn)]ₘₐₓ Equation 1

where X represents C, M or Y, n is an integer associated with each density patch printed as part of a test image, and [NΔR_{S}(Xn)]ₘₐₓ is the maximum value of the normalized differential specular reflectances that are calculated for the density patches printed using the ink composition; wherein the image-recording element has a gloss value of at least 5 when measured at 60°; wherein the test image for the ink composition consists of a series of at least ten density patches printed such that the ink laydown on the patches increases incrementally, from no ink laydown to a maximum level generating a density of at least 1.5; and wherein the normalized differential specular reflectance value for each patch, NΔR_{S}(Xn), is determined according to Equation 2:

$$N Δ {R}_{S} ( X n ) = \frac{[ {R}_{S max} ( X n ) - {R}_{S min} ( X n ) ]}{{R}_{S mean} ( X n )} \qquad Equation 2$$

where R_{Smax}(Xn) is the maximum specular reflectance over the visible spectral region between 390 nm and 720 nm for patch Xn, R_{Smin}(Xn) is the minimum specular reflectance over the visible spectral region between 390 nm and 720 nm for patch Xn, and R_{Smean}(Xn) is the average specular reflectance over the visible spectral region between 390 nm and 720 nm for patch Xn.

### BRIEF DESCRIPTION OF THE DRAWINGS

While the specification concludes with claims particularly pointing out and distinctly claiming the subject matter of the present invention, it is believed the invention will be better understood from the following detailed description when taken in conjunction with the accompanying drawings wherein:

FIG. 1 shows light reflecting off the surface of a glossy image-recording element.

FIG. 2 shows light reflecting off the surface of a matte image-recording element.

### DETAILED DESCRIPTION OF THE INVENTION

Spectral Reflectance Properties

It is well known in the art of color measurement that the color appearance of an opaque object is in part due to the behavior of light that is reflected from the object. (For a complete description of color measurement refer to “Measuring Color”, 2nd Edition by R. W. G. Hunt, published by Ellis Horwood Ltd., 1991.) Reflectance is evaluated in terms of diffuse reflectance and specular reflectance. (For a complete description of reflectance spectroscopy refer to “Chemical Analysis”, Volume 21, by W. W. Wendlandt and H. G. Hecht, published by Interscience Publishers, 1966, Chapters 2 and 3.) Most of the radiation from the light source enters the object and is partially absorbed or scattered as the material interacts with the light. One observes the resultant fraction of the light that either passes through the object (transmittance) or scatters back from the object (diffuse reflectance). Specular reflection occurs when a fraction of the incident light never penetrates the object, but rather interacts with and scatters off the interface between the first medium, usually air, and the object. Diffuse reflectance is typically dispersed equally in all directions (referred to as lambertian reflectance) when emerging from the observed object, while specular reflectance can be highly directional, depending on the roughness of the surface.

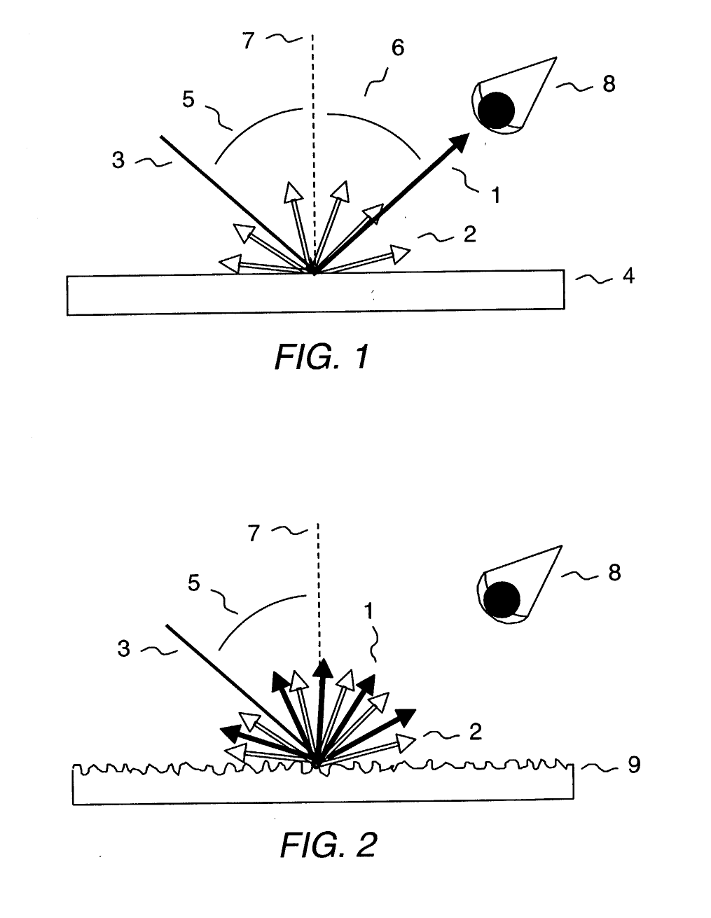

As shown in FIG. 1, specular reflectance 1 and diffuse reflectance 2 occur when incident light 3 strikes the surface of a glossy image-recording element 4. The angle of incidence (Θᵢ) 5 is the angle at which light strikes the image-recording element, and the complement angle is the angle of reflectance (Θᵣ) 6, where Θᵣ=−Θᵢ. Both Θᵢ and Θᵣ are defined relative to the normal 7 to the average plane of the image-recording element. Element 8 represents an observer or a detector. Gloss is the light reflected back from an object at Θᵣ and is dominantly specular reflectance. Diffuse reflectance is reflected back at all angles.

As shown in FIG. 2, specular reflectance 1 and diffuse reflectance 2 occur when incident light 3 strikes the surface of a matte image-recording element 9. Both specular and diffuse reflectance occur at all angles, such that little or no gloss is observed.

Ink jet image-recording elements are available in a variety of finishes such as matte, satin, semi-glossy and glossy. The finish that one observes is directly dependent upon the amount of diffuse and specular reflectance that occurs when light interacts with the image-recording element. The amount of specular reflectance is in turn dependent upon the surface of the image-recording element. If the surface of an image-recording element is rough, light reflects from the surface in all directions, and the image-recording element will have a matte appearance. In contrast, if the surface of an image-recording element is smooth, light reflects from the surface in primarily one direction, and the image-recording element will have a glossy appearance.

Glossy image-recording elements may have gloss values ranging from 5 to 90 when measured at 60°. Examples of glossy image-recording elements are Kodak Instant-Dry Photographic Glossy Media having Cat. No. 8103137 (60° gloss of 64), Epson Photoglossy Paper having Cat. No. SP91001 (60° gloss of 34), and Kodak Instant-Dry Photographic Satin Media having Cat. No. 8648263 (60° gloss of 30). Many examples of matte, satin, semi-glossy and glossy image-recording elements to be used for ink jet printing have been described in the patent literature, see for example, U.S. Pat. Nos. 6,045,917; 5,605,750; 5,723,211; 5,789,070 and EP 813 978 A1.

When ink jet inks are printed on ink jet image-recording elements, components of the ink composition may reside at the surface of the printed image even after the printed image is completely dry. If the components at the surface are colorants, then the amount of specular reflectance is dependent on the colorant. Because colorants absorb light in the visible spectral region, the specular reflectance varies as a function of wavelength and appears as chromatic gloss.

The problem of chromatic gloss is significant for printed images in which pigment-based inks have been printed on glossy image-recording elements. Pigment colorants may be up to 0.5 μm in diameter; this is much bigger than the pores created at the surface of a smooth glossy porous image-recording element. In such cases, pigment colorants cannot be pulled into the pores of the image-recording element via capillary action and remain trapped at the surface of the image-recording element. Pigment colorants are typically too large to diffuse into swellable nonporous media. In both cases, chromatic gloss is commonly observed.

The present invention discloses that a particular spectral reflectance property for an ink jet ink composition can be used to determine the extent to which chromatic gloss will be observed for the ink composition printed on an image-recording element. The ink composition is pigment-based, and may be any hue, preferably a hue that is well known in the art of ink jet printing. For example, the hue may be cyan, magenta, yellow, black, orange, green, violet, or brown. The ink composition may contain any amount of colorant in order to render a range of densities on an image-recording element. The spectral reflectance property is the normalized differential specular reflectance of the ink, NΔR_{S}(X):

NΔR_{S}(X)=[NΔR_{S}(Xn)]ₘₐₓ Equation 1

where X represents the ink, n is an integer associated with each density patch printed as part of a test image, and [NΔR_{S}(Xn)]ₘₐₓ is the maximum value of the normalized differential specular reflectances that are calculated for the density patches printed using ink X.

The test image for ink X consists of a series of at least ten density patches printed such that the ink laydown on the patches increases incrementally, from no ink laydown to a maximum level generating a density of at least 1.5. The test image is printed on an image-recording element having a gloss value of at least 5 when measured at 60°. The normalized differential specular reflectance value for each patch, NΔR_{S}(Xn), is determined according to:

$$N Δ {R}_{S} ( X n ) = \frac{[ {R}_{S max} ( X n ) - {R}_{S min} ( X n ) ]}{{R}_{S mean} ( X n )} \qquad Equation 2$$

where R_{Smax}(Xn) is the maximum specular reflectance over the visible spectral region between 390 nm and 720 nm for patch Xn, R_{Smin}(Xn) is the minimum specular reflectance over the visible spectral region between 390 nm and 720 nm for patch Xn, and R_{Smean}(Xn) is the average specular reflectance over the visible spectral region between 390 nm and 720 nm for patch Xn.

NΔR_{S}(Xn) is determined by illuminating a density patch at Θᵢ=45° as the angle of incidence 5, and measuring the reflected light intensity using a spectroradiometer oriented at Θᵣ=−45° as the angle of reflectance 6. The result is referenced to the reflectance of a calibrated (NIST) piece of polished black glass measured using Θᵢ=45° and Θᵣ=−45°. R_{Smax}(Xn), R_{Smin}(Xn) and R_{Smean}(Xn) are determined and used to calculate NΔR_{S}(Xn) for each patch according to Equation 2. The resulting NΔR_{S}(Xn) values are used to calculate NΔR_{S}(X) according to Equation 1. In order to minimize objectionable chromatic gloss, desirable values of NΔR_{S}(X) are: less than 1.25 for NΔR_{S}(C), less than 0.50 for NΔR_{S}(M), and less than 0.30 for NΔR_{S}(Y).

Pigment-Based Inks

The process of preparing inks from pigments commonly involves two steps: (a) a dispersing or milling step to break up the pigment to the primary particles, and (b) a dilution step in which the dispersed pigment concentrate from step (a) is diluted with a carrier and other addenda to a working strength ink. In the milling step, the pigment is usually suspended in a carrier (typically the same carrier as that in the finished ink) along with rigid, inert milling media. Mechanical energy is supplied to this pigment concentrate, and the collisions between the milling media and the pigment cause the pigment to deaggregate into its primary particles. A dispersant or stabilizer, or both, may be added to the dispersed pigment concentrate to facilitate the deaggregation, maintain particle stability, and retard particle reagglomeration and settling.

There are many different types of materials that may be used as milling media, such as glasses, ceramics, metals, and plastics. In a preferred embodiment, the grinding media can comprise particles, preferably substantially spherical in shape, e.g., beads, consisting essentially of a polymeric resin. In general, polymeric resins suitable for use as milling media are chemically and physically inert, substantially free of metals, solvent and monomers, and of sufficient hardness and firability to enable them to avoid being chipped or crushed during milling. Suitable polymeric resins include crosslinked polystyrenes, such as polystyrene crosslinked with divinylbenzene, styrene copolymers, polyacrylates such as poly(methyl methylacrylate), polycarbonates, polyacetals, such as Derlin™, vinyl chloride polymers and copolymers, polyurethanes, polyamides, poly(tetrafluoroethylenes), e.g., Teflon®, and other fluoropolymers, high density polyethylenes, polypropylenes, cellulose ethers and esters such as cellulose acetate, poly(hydroxyethylmethacrylate), poly(hydroxyethylacrylate), silicone containing polymers such as polysiloxanes and the like. The polymer can be biodegradable. Exemplary biodegradable polymers include poly(lactides), poly(glycolids) copolymers of lactides and glycolide, polyanhydrides, poly(imino carbonates), poly(N-acylhydroxyproline) esters, poly(N-palmitoyl hydroxyprolino) esters, ethylene-vinyl acetate copolymers, poly(orthoesters), poly(caprolactones), and poly(phosphazenes). The polymeric resin can have a density from 0.9 to 3.0 g/cm³. Higher density resins are preferred inasmuch as it is believed that these provide more efficient particle size reduction. Most preferred are crosslinked or uncrosslinked polymeric media based on styrene.

Milling can take place in any suitable grinding mill. Suitable mills include an air jet mill, a roller mill, a ball mill, an attritor mill and a bead mill. A high-speed, high-energy mill is preferred by which the milling media obtain velocities greater than 5 meters per second. In the present invention, a sawtooth impeller having a diameter of 40 mm when operated at 9,000 rpm (available from Morehouse-Cowles Hockmeyer) is used. The preferred proportion of milling media, pigment, carrier and optional dispersant can vary within wide limits and depends, for example, upon the particular pigment, the size and density of the milling media, and the particular printing application. For pigment-based inks of the invention, the pigment is present in the dispersed pigment concentrate at 1 to 50 wt. %, and the weight ratio of pigment to dispersant is 20:1 to 1:2. After milling is complete, the dispersed pigment concentrate is separated from the milling media by simple sieving or filtration.

The dispersant is an optional ingredient used to prepare the dispersed pigment concentrate. Preferred dispersants used in the present invention include sodium dodecyl sulfate, acrylic and styrene-acrylic copolymers, such as those disclosed in U.S. Pat. Nos. 5,085,698 and 5,172,133, and sulfonated polyesters and styrenics, such as those disclosed in U.S. Pat. No. 4,597,794. Other patents referred to above in connection with pigment availability also disclose a wide variety of dispersant to select from. The dispersant used in the examples is potassium N-methyl-N-oleoyl taurate. Dispersants may not be necessary if the pigment particles themselves are stable against flocculation and settling. Self-dispersing pigments are an example of pigments that do not require a dispersant; these types of pigments are well known in the art of ink jet printing.

The milling time can vary widely and depends upon the pigment, milling means and residence conditions selected, the initial and desired final particle size, etc. In the present invention, milling times typically range from 1 to 100 hours.

The pigment particles useful in the invention may have any particle size that can be jetted through an ink jet printhead. The pigment particles may have a mean particle size of up to 0.5 μm. Preferably, the pigment particles have a mean particle size of less than 0.3 μm, more preferably less than 0.15 μM.

A wide variety of organic and inorganic pigments, alone or in combination, may be selected for use in the ink compositions of the present invention. Pigments that may be used in the invention include those disclosed in, for example, U.S. Pat. Nos. 5,026,427; 5,086,698; 5,141,556; 5,160,370; and 5,169,436, the disclosures of which are incorporated herein by reference. The exact choice of pigments will depend upon the specific application and performance requirements such as color reproduction and image stability.

Pigments suitable for use in the present invention include, for example, azo pigments, monoazo pigments, disazo pigments, azo pigment lakes, β-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, and iron oxide.

Typical examples of pigments that may be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; and C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66. In a preferred embodiment of the invention, the pigment is C.I. Pigment Blue 15:3, C.I. Pigment Red 122, C.I. Pigment Yellow 155, C.I. Pigment Yellow 74, or a bis(phthalocyanylalumino)tetraphenyldisiloxane as described in U.S. Pat. No. 4,311,775, the disclosure of which is incorporated herein by reference.

Pigments useful in the invention include composite colorant particles which are pigments which have been encapsulated with polymer. Composite colorant particles have been described in EP 1 006 161; U.S. Pat. No. 5,852,073; and U.S. Pat. Ser. Nos. 09/822,723; 09/822,724; 09/822,725; and 09/822,096; the disclosures of which are incorporated herein by reference.

The pigment used in the ink composition of the present invention is present in any effective amount, generally from 0.1 to 10 wt. %, and preferably from 0.5 to 6 wt. %.

Polymers may be used in the ink compositions of the present invention. Any homopolymer or copolymer can be used in the present invention provided it can be stabilized in an aqueous medium, particularly an aqueous basic medium. Useful polymers include those generally classified as either water soluble, water reducible, or water dispersible. By the term “water soluble” is meant herein that the polymer is dissolved in water such that scattering is not observed when a dilute solution of the polymer is analyzed using dynamic light scattering or any other technique well known in the art of particle analysis.

By the term “water reducible” is meant herein that the polymer can be diluted with water to form reasonably stable dispersions of polymer aggregates swollen by solvent and water, as described in “Organic Coatings: Science and Technology”, 2nd Edition by Wicks, Jones and Papas, published by Wiley-Interscience, 1999.) By the term “water dispersible” is meant herein that the polymer exists in the form of particles in water, the particles being dispersed or suspended and often stabilized against flocculation and settling by the use of dispersing agents. In contrast to a water soluble polymer, a dilute solution of a water dispersible polymer exhibits scattering when analyzed using dynamic light scattering or any other technique well known in the art of particle analysis.

Polymers useful in the ink compositions of the invention include those referred to as addition polymers, which are prepared by free radical polymerization of vinyl or ethylenically unsaturated monomers. In a preferred embodiment, the addition polymer is derived from acrylic monomers which are well known in the art of polymer chemistry. The term “acrylic monomer” as employed herein includes, but is not limited to, acrylic acid, acrylate esters and derivatives and mixtures thereof. Examples of acrylic acid monomers include but are not limited to alkylacrylic acids, 3-alkylacrylic acids and 3-haloacrylic acids. Specific examples include crotonic acid, cinnamic acid, citraconic acid, sorbic acid, fumaric acid, methacrylic acid, ethacrylic acid, 3-methylacrylic acid, 3-chloroacrylic acid and 3-chloromethacrylic acid.

Examples of acrylate esters include but are not limited to alkyl acrylates, aryl acrylates, alkyloxyalkyl acrylates, alkyloxyaryl acrylates, hydroxyalkyl acrylates, hydroxyaryl acrylates, crotonic esters, cinnamic esters, citraconic esters, sorbic esters and fumaric esters. Specific examples include n-butyl acrylate, methyl acrylate, ethyl acrylate, n-propyl acrylate, isopropyl acrylate, amyl acrylate, hexyl acrylate, n-octyl acrylate, lauryl acrylate, 2-chloroethyl acrylate, phenyl acrylate, benzyl acrylate, allyl acrylate, methyl 3-chloroacrylate, 2-ethylhexyl acrylate, 2-methoxyethyl acrylate, 2-(2-methoxyethoxy)ethyl acrylate, 2-ethoxyethyl acrylate, 2-(2-ethoxyethoxyl)ethyl acrylate, 2-hydroxyethyl acrylate, 2-hydroxypropyl acrylate, glycidyl acrylate, N,N-dimethylaminoethyl acrylate, trifluoroethyl acrylate, 2-sulfoethyl acrylate and the corresponding methacrylates.

Acrylic monomers useful in the invention also include unsaturated anhydride and unsaturated imide monomers which may be completely or partially hydrolyzed after polymerization to form the corresponding carboxylic acid or amide functionality. Specific examples include but are not limited to maleic anhydride, methylmaleic anhydride, glutaconic anhydride, itaconic anhydride, citraconic anhydride, mesaconic anhydride, maleimide and N-methylmaleimide. Also useful are mono-ester and bis-ester derivatives of the aforementioned.

Other acrylic monomers useful in the invention include acrylamide and derivatives such as but not limited to N-alkyl acrylamides, N-aryl acrylamides and N-alkoxyalkyl acrylamides. Specific examples include N-methyl acrylamide, N-ethyl acrylamide, N-butyl acrylamide, N,N-dimethyl acrylamide, N,N-dipropyl acrylamide, N-(1,1,2-trimethylpropyl) acrylamide, N-(1,1,3,3-tetramethylbutyl) acrylamide, N-methoxymethyl acrylamide, N-methoxyethyl acrylamide, N-methoxypropyl acrylamide, N-butoxymethyl acrylamide, N-isopropyl acrylamide, N-s-butyl acrylamide, N-t-butyl acrylamide, N-cyclohexyl acrylamide, N-(1,1-dimethyl-3-oxobutyl) acrylamide, N-(2-carboxyethyl) acrylamide, 3-acrylamido-3-methyl butanoic acid, methylene bisacrylamide, N-(3-aminopropyl) acrylamide hydrochloride, N-(3,3-dimethylaminopropyl) acrylamide hydrochloride, N-(1-phthalamidomethyl) acrylamide, sodium N-(1,1-dimethyl-2-sulfoethyl) acrylamide and the corresponding methacrylamides.

Addition polymers useful in the ink compositions of the invention include those derived from styrenic monomers which are well known in the art of polymer chemistry. The term “styrenic monomer” as employed herein includes, but is not limited to, α-alkylstyrenes, trans-β-alkylstyrenes, alkylstyrenes, alkoxystyrenes, halogenated styrenes, vinyl naphthalenes and mixtures thereof. Specific examples of styrenic derivatives include styrene, α-methylstyrene, trans-β-methylstyrene, 3-methylstyrene, 4-methylstyrene, 3-ethyl styrene, 3-isopropyl styrene, 3-butyl styrene, 3-cyclohexyl styrene, 3,4-dimethyl styrene, 3-chlorostyrene, 3,4-dichloro styrene, 3,4,5-trichloro styrene, 3-bromo styrene, 3-iodo styrene, 3-fluoro styrene, 3-chloro-4-methyl styrene, benzyl styrene, vinyl naphthalene, divinylbenzene, methyl vinylbenzoate ester, vinylbenzoic acid, vinyl phenol, 3-methoxy styrene, 3,4-dimethoxy styrene, 3-methyl-4-methoxy styrene, acetoxystyrene, acetoxymethylstyrene and (t-butoxycarbonyloxy) styrene. The styrenic monomers may be substituted with ionic functionalities such as sulfonate and carboxylate. Specific examples include sodium styrenesulfonate and sodium vinylbenzoate.

Besides being derived from acrylic and styrenic monomers, the addition polymers useful in the invention may be derived from a variety of other types of monomers well known in the art of polymer chemistry. Such monomers include vinyl derivatives and ethylenically unsaturated compounds in general. Examples of these other monomer types include, but are not limited to, α-alkylalkenes, acrylonitriles, acroleins, vinyl ethers, vinyl esters, vinyl ketones, vinylidene chloride compounds, allyl compounds, and ethylenically unsaturated heterocyclic compounds. Specific examples include allyl acetate, allyl caproate, methyl vinyl ether, butyl vinyl ether, methoxyethyl vinyl ether, ethoxyethyl vinyl ether, chloroethyl vinyl ether, 1-methyl-2,2-dimethylpropyl vinyl ether, hydroxyethyl vinyl ether, diethylene glycolvinyl ether, dimethylaminoethyl vinyl ether, butylaminoethyl vinyl ether, benzyl vinyl ether, tetrahydrofurfuryl vinyl ether, vinyl acetate, vinyl propionate, vinyl butyrate, vinyl isobutyrate, vinyl dimethyl propionate, vinyl ethyl butyrate, vinyl chloroacetate, vinyl dichloroacetate, vinyl methoxyacetate, vinyl phenyl acetate, vinyl acetoacetate, N-vinyl oxazolidone, N-vinylimidazole, N-vinylpyrrolidone, N-vinylcarbazole, vinyl thiophene and N-vinylethyl acetamide. Still other monomer types include multifunctional monomers having some combination of functionality described above.

Cross-linkable functional groups well known in the art of polymer chemistry may also be imparted to any one of the monomers described above, either before or after polymerization. The addition polymer employed in the invention is then generated by reaction of the cross-linkable functional groups under conditions well known in the art of polymer chemistry. The addition polymer employed in the invention may be derived from a random copolymer, a block copolymer, a graft copolymer, or an alternating copolymer.

Useful addition polymers are disclosed in, for example, U.S. Pat. Nos. 4,529,787; 4,358,573; 4,522,992; 4,546,160; and U.S. patent application Ser. No. 10/284,957 filed Oct. 31, 2002; the disclosures of which are incorporated herein by reference. Typical addition polymers are, in general, styrene-acrylic acids, styrene-acrylic acid-alkyl acrylates, styrene-maleic acids, styrene-maleic acid-alkyl acrylates, styrene-methacrylic acids, styrene-methacrylic acid-alkyl acrylates, and styrene-maleic acid half esters. Examples of typical addition polymers include but are not limited to styrene-acrylic acid, (3-methyl styrene)-acrylic acid, and styrene-methacrylic acid; terpolymers such as styrene-butyl acrylate-acrylic acid, styrene-butyl methacrylate-acrylic acid, styrene-methyl methacrylate-acrylic acid; and tetrapolymers such as styrene-butyl acrylate-ethyl acrylate-acrylic acid and styrene-(α-methylstyrene)-butyl acrylate-acrylic acid.

Specific examples of preferred addition polymers include commercially available polymers such as Joncryl® 57, Joncryl® 59, Joncryl® 63 and Joncryl® 70, all from S.C. Johnson Co.; TruDot™ IJ-4655 and TruDot™ IJ-4680, both from MeadWestvaco Corp.; and Vancryl® 68S from Air Products and Chemicals, Inc.

Polymers useful in the ink compositions of the invention include those referred to as condensation polymers, which are prepared by condensing a variety of different types of monomers to form polyesters, polyurethanes, polyamides, polyureas, polyethers, polycarbonates, polyacid anhydrides, and polymers comprising combinations of the above-mentioned types. Useful polyesters and polyurethanes are disclosed in U.S. patent application Ser. No. 09/887,183 filed Jun. 21, 2001; and Ser. No. 10/284,958 filed Oct. 31, 2002; the disclosures of which are incorporated herein by reference. In a preferred embodiment, polyesters having the following general formula are used:

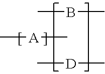

where A, B and D represent segments which have been condensed to form the polyester.

The A segment is derived from one or more compounds having diol functionality and is represented by the following structure:

—O—[(CHR₂CHR₃₀)ₘ—R₁—(OCHR₂CHR₃)ₙ]—O—

where m and n independently represent an integer from 0-4;

R₁ represents an alkyl group of 1 to 16 hydrocarbon groups; a cycloalkyl group of 5 to 20 hydrocarbon groups; a cyclobisalkyl hydrocarbon group of 8 to 20 carbon atoms, a bi- or tri-cycloalkyl hydrocarbon group of 7 to 16 carbon atoms, a bi- or tri-cyclobisalkyl hydrocarbon group of 9 to 18 carbon atoms, an arenebisalkylene hydrocarbon group of from 8 to 20 carbon atoms or an arylene hydrocarbon group of 6 to 12 carbon atoms;

R₂ and R₃ each independently represents H, a substituted or unsubstituted alkyl group of 1 to 6 carbon atoms or a substituted or unsubstituted aryl group of 6 to 12 carbon atoms; and

the A segment is preferably derived from ethylene glycol, diethylene glycol, triethylene glycol, thiodiethanol, cyclohexanedimethanol, bisphenol A, trans-1,4-cyclohexanediol, dodecanediol, cis-exo-2,3-norbornanediol, 5-norbornene-2,2-dimethanol, hydroquinone bis(2-hydroxyethylether), or a hydroxy terminated polydimethylsiloxane.

The B segment is derived from one or more compounds having bis-carboxylic acid functionality which undergo condensation to form the backbone of the polyester. The B segment has functionality which is capable of becoming ionized to negatively and positively charged species in an aqueous-based solution. Examples of such functional groups are phosphonate, carboxylate, and sulfonate salts. B is represented by any one of the following structures:

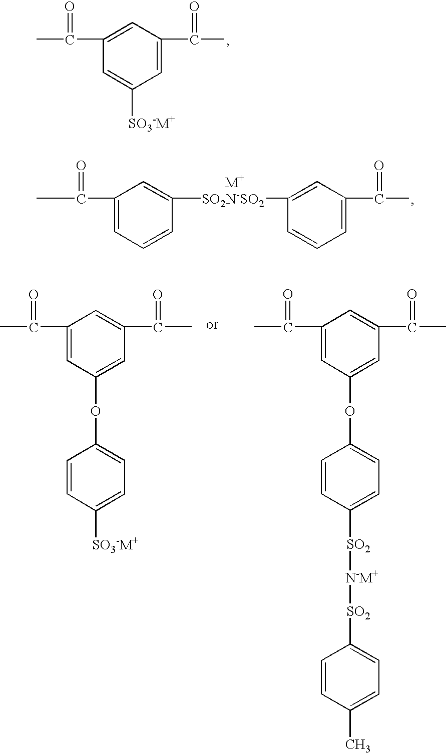

where M⁺ represents an alkali metal such as Li⁺, Na⁺ or K⁺; or an organic cation such as ammonium derivatives, for example, ammonium, methylammonium, triethylammonium, tetralkylammonium, aryltrialkylammonium, etc.; phosphonium derivatives, for example, triphenylphosphonium and tetrabutylphosphonium; heteroaromatic ammonium derivatives, for example, pyridinium, imidazolium and N-methylammonium; sulfonium groups; guanidinium groups; amidinium groups, etc.

The D segment is derived from one or more compounds having bis-carboxylic acid functionality and is represented by any one of the following structures:

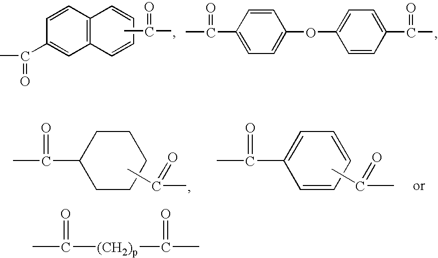

where p represents an integer from 2 to 12.

The A, B and D segments can be used in any ratio; the relative amount of the A segment is preferably 2-7, the relative amount of the B segment is preferably up to 2, and the relative amount of the D segment is preferably 1-6.

Specific examples of preferred polyesters include the water dispersible Eastman AQ® polyesters available from Eastman Chemical Co. Eastman AQ® 29, Eastman AQ® 38, and Eastman AQ® 55 are each composed of varying amounts of isophthalic acid, sodium sulfoisophthalic acid, diethylene glycol, and 1,4-cyclohexanedimethanol.

In another preferred embodiment, polyurethanes having the following general formula are used:

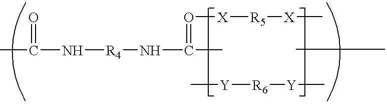

where R₄ represents the central portion of a diisocyanate which has been condensed to form the polyurethane. R₄ is a substituted or unsubstituted alicyclic, aliphatic, or aromatic group, preferably represented by one or more of the following groups:

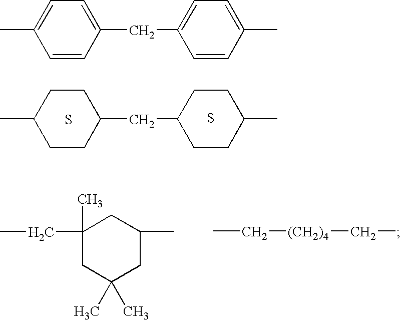

The segment X—R₅—X is derived from one or more compounds which are diamines, polyamines, diols or polyols which have been condensed to form the polyurethane. X—R₅—X is preferably derived from ethylene diamine; diethylene triamine; propylene diamine; butylene diamine; hexamethylene diamine; cyclohexylene diamine; phenylene diamine; tolylene diamine; xylylene diamine; 3,3′-dinitrobenzidene; ethylene methylenebis(2-chloroaniline); 3,3′-dichloro-4,4′-biphenyl diamine; 2,6-diaminopyridine; 4,4′-diamino diphenylmethane; adducts of diethylene triamine with acrylate or its hydrolyzed products; hydrazine; a substituted hydrazine; neopentyl glycol, ethylene glycol; propylene-1,2-glycol; propylene-1,3-glycol; diethylene glycol; butane-1,4-diol; hexane-1,6-diol; octane-1,8-diol; neopentyl glycol; 2-methyl propane-1,3-diol; or the various isomeric bis-hydroxymethylcyclohexanes; a dihydroxy polyester obtained by esterification of a dicarboxylic acid such as succinic acid, adipic acid, suberic acid, azelaic acid, sebacic acid, phthalic, isophthalic, terephthalic, tetrahydrophthalic acid; a polylactone such as polymers of ε-caprolactone and one of the above-mentioned diols; or a polycarbonate obtained, for example, by reacting one of the above-mentioned diols with diaryl carbonates or phosgene.

The segment Y—R₆—Y is derived from one or more compounds which are diamines, polyamines, diols or polyols such as those described above, but which have functionality which is capable of becoming ionized to negatively and positively charged species in an aqueous-based solution. Examples of such functional groups are phosphonate, carboxylate, and sulfonate salts.

The diisocyanate, X—R₅—X and Y—R₆—Y can be used in any ratio; the relative amount of the diisocyanate is preferably 0.2-5, the relative amount of X—R₅—X is preferably up to 5, and the relative amount of Y—R₆—Y is preferably 0.02-4.

The addition polymers and the condensation polymers used in the ink compositions of the invention are present in an amount necessary to give NΔR_{S}(C) less than 1.25, NΔR_{S}(M) less than 0.50, and NΔR_{S}(Y) less than 0.30, but without affecting any of the desirable performance features of the ink composition. In particular, the amount of polymer used must be low enough such that the ink composition is jettable using an ink jet printhead. The necessary amount depends upon the particular polymer being used, as well as the identities and amounts of the other components in the ink composition. In a preferred embodiment, the polymer is used in an amount such that the ratio of polymer to pigment is at least 0.5. In another preferred embodiment, the ratio of polymer to pigment is at least 0.7.

The molecular weights of the polymers used in the invention must be high enough to give NΔR_{S}(C) less than 1.25, NΔR_{S}(M) less than 0.50, and NΔR_{S}(Y) less than 0.30, but low enough such that the ink composition is jettable using an ink jet printhead. A preferable number average molecular weight range is from 2000 to 300,000. An even more preferable number average molecular weight range is from 2000 to 100,000; especially preferable is a number average molecular weight range of from 2000 to 50,000.

The pigment-based ink compositions of the invention may include any other addenda to give NΔR_{S}(C) less than 1.25, NΔR_{S}(M) less than 0.50, and NΔR_{S}(Y) less than 0.30. Examples of other addenda include non-volatile organic compounds which do not penetrate the surface of the recording element upon which the ink composition has been printed. In a preferred embodiment, glycol-containing oligomers are used.

Representative examples of water miscible humectants and water miscible organic co-solvents include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol, tetraethylene glycol, propylene glycol, polyethylene glycol, glycerol, 2-methyl-2,4-pentanediol, 1,2,6-hexanetriol, 2-ethyl-2-hydroxymethyl-1,3-propanediol, 1,5 pentanediol, 1,2-hexanediol, and thioglycol; (6) lower mono-alkyl ethers derived from alkylene glycols, such as the mono-methyl, mono-ethyl, mono-propyl and mono-butyl ethers of ethylene glycol, diethylene glycol, triethylene glycol, propylene glycol, and poly(ethylene glycol); (7) lower di-alkyl ethers derived from alkylene glycols, such as the di-methyl, di-ethyl, di-propyl and di-butyl ethers of ethylene glycol, diethylene glycol, triethylene glycol, propylene glycol, and poly(ethylene glycol); (8) nitrogen containing compounds, such as urea, 2-pyrrolidone, N-methyl-2-pyrrolidone, and 1,3-dimethyl-2-imidazolidinone; and (9) sulfur-containing compounds such as dimethyl sulfoxide, 2,2′-thiodiethanol, and tetramethylene sulfone.

Preferred humectants for the ink compositions of the invention include diethylene glycol, glycerol, ethylene glycol butyl ether, and mixtures thereof. Humectants may be used in an amount of from 5 to 60 wt. %, preferably in an amount of from 5 to 30 wt. %.

Typically, the amount of aqueous carrier employed in the ink compositions is in the range of approximately 70 to 98 wt. %, preferably approximately 90 to 98 wt. %, based on the total weight of the ink. In a preferred embodiment, the ink compositions contain from 5 to 60 wt. % of one or more water miscible humectants and/or water miscible organic co-solvents, based on the total weight of the ink.

Other additives which may optionally be present in the ink compositions of the invention include surfactants, penetrants, biocides, thickeners, conductivity enhancing agents, anti-kogation agents, drying agents, waterfast agents, dye solubilizers, chelating agents, binders, light stabilizers, viscosifiers, buffering agents, anti-mold agents, anti-curl agents, stabilizers and defoamers.

Surfactants may be added to the ink compositions to adjust the surface tension to an appropriate level. The surfactants may be anionic, cationic, amphoteric or nonionic and used at levels of 0.01 to 2 wt. %. Preferred surfactants include Surfynol® 465 (Air Products and Chemicals, Inc.) and Silwet® L-77 (Witco Corp.).

A biocide may be added to the ink compositions employed in the invention to suppress the growth of microorganisms such as molds, fungi, etc. in aqueous inks. A preferred biocide for the ink compositions employed in the present invention is Proxel® GXL (Avecia Corp.) at a final concentration of 0.0001-0.5 wt. %.

Particles may be added to the ink compositions employed in the invention in order to minimize variations in gloss between imaged areas of different colors in a printed image, as described in U.S. patent application Ser. Nos. 10/032,931; 10/033,229; 10/034,281 and 10/034,285 filed on Dec. 28, 2001. Useful particles include silica, alumina, titanium dioxide, zircona, clay, calcium carbonate, barium sulfate, zinc oxide, polymeric particles, or mixtures thereof.

The pH of the ink compositions employed in the invention may be adjusted by the addition of organic or inorganic acids or bases. Useful ink compositions may have a preferred pH of from 2 to 10. Typical inorganic acids include hydrochloric, phosphoric and sulfuric acids. Typical organic acids include methanesulfonic, acetic and lactic acids. Typical inorganic bases include alkali metal hydroxides and carbonates. Typical organic bases include ammonia, triethanolamine and tetramethylethylenediamine.

Image-Recording Elements

Any image-recording element having a gloss value of at least 5 when measured at 60° may be used to determine NΔR_{S}(X). However, the pigment-based ink compositions of the present invention may be used in combination with any type of image-recording element suitable for use in ink jet printing.

Ink jet image-recording elements useful in the invention typically comprise an ink-receiving or image-forming layer coated on a support. The ink-receiving layer may be of the porous type having micropores that imbibe the ink via capillary action. Porous ink-receiving layers usually have at least 20 wt. % of particles and less than 50 wt. % of a polymeric binder. Useful particles include silica, alumina, titanium dioxide, clay, calcium carbonate, barium sulfate, zinc oxide, polymeric particles and mixtures thereof. Common polymeric binders are gelatin, poly(vinyl alcohol), poly(vinyl pyrrolidinone), poly(vinyl acetate), a cellulose derivative, or derivatives thereof. The ink-receiving layer may be of the nonporous type wherein the ink components must diffuse into the nonporous layer and cause it to swell. Nonporous ink-receiving layers consist primarily of common polymeric binders such as the ones described above.

Preferred ink jet image-recording elements having porous ink-receiving layers are Kodak Instant-Dry Photographic Glossy Media having Cat. No. 8103137, Epson Photoglossy Paper having Cat. No. SP91001, and Kodak Instant-Dry Photographic Satin Media having Cat. No. 8648263. Also preferred are the image-recording elements described in U.S. Pat. Nos. 6,045,917; 5,605,750; 5,723,211; 5,789,070; EP 1 002 660; EP 813 978 A1; and U.S. patent application Ser. No. 09/944,547 of Sadasivan et al., filed Aug. 31, 2001; all of which the disclosures are incorporated herein by reference.

Another type of porous ink-receiving layer is made from a polymeric open-pore membrane as described in, for example, U.S. patent application Ser. No. 10/251,936 of Campbell et al., filed on Sep. 20, 2002, the disclosure of which is incorporated herein by reference.

The image-recording elements useful in the combination of the invention may consist of a variety of different kinds of supports, all of which are described in the references above. In a preferred embodiment, the support is paper or polyethylene-coated paper such as the type used in photographic paper.

The following example is provided to illustrate the invention.

### EXAMPLE

Preparation of Pigment Dispersions

Cyan Pigment Dispersion

A mixture of 325 g of polymeric beads having mean diameter of 50 μm, 30.0 g of Pigment Blue 15:3 (Sun Chemical Corp.); 10.5 g of potassium oleoyl methyl taurate (KOMT) and 209.5 g of deionized water was prepared. These components were milled for 8 hours in a double walled vessel at room temperature using a high-energy media mill manufactured by Morehouse-Cowles Hochmeyer. The mixture was filtered through a 4-8 μm Buchner funnel to remove the polymeric beads, and the resulting filtrate diluted to give a Cyan Pigment Dispersion having a 10.0 wt. % final concentration of pigment. The median particle size of the pigment was 40 nm, as determined using a MICROTRAC II Ultrafine particle analyzer (UPA) manufactured by Leeds & Northrup. Proxel® GXL (Avecia Corp.) was added at an amount necessary to give 230 ppm concentration.

Magenta Pigment Dispersion

The Magenta Pigment Dispersion was prepared the same as the Cyan Pigment Dispersion except that Pigment Red 122 (Sun Chemical Corp.) was used instead of Pigment Blue 15:3. The final concentration of pigment was 11.6 wt. % and the mean particle size was 15 nm.

Yellow Pigment Dispersion

The Yellow Pigment Dispersion was prepared the same as the Cyan Pigment Dispersion except that Pigment Yellow 155 (Clariant Corp.) was used instead of Pigment Blue 15:3. The final concentration of pigment was 10.0 wt. %, and the mean particle size was 10 nm.

Preparation of Ink Compositions

Cyan Ink C-1 of the Invention

Cyan Ink C-1 was prepared using the Cyan Pigment Dispersion described above to give 1.4 wt. % of pigment relative to the total weight of the ink. Other additives included diethylene glycol at 6.5 wt. %, glycerol at 3 wt. %, ethylene glycol butyl ether (Dowanol® EB from Dow Chemical Co.) at 2.5 wt. %, Surfynol® 465 (Air Products and Chemicals, Inc.) at 0.2 wt. %, and Joncryl® 70, a styrene-acrylic copolymer available from S.C. Johnson Co., at 0.95 wt. % relative to the total weight of the ink. The ratio of copolymer to pigment was 0.7.

Cyan Ink C-2 of the Invention

Cyan Ink C-2 was prepared the same as Cyan Ink C-1 except that TruDot™ IJ-4655, a styrene-acrylic copolymer available from MeadWestvaco Corp., was used instead of Joncryl® 70.

Cyan Ink C-3 of the Invention

Cyan Ink C-3 was prepared using the Cyan Pigment Dispersion described above to give 1.4 wt. % of pigment relative to the total weight of the ink. Other additives included diethylene glycol at 11.0 wt. %, glycerol at 6.0 wt. %, ethylene glycol butyl ether at 2.5 wt. %, Silwetg L-77 (Witco Corp.) at 1.0 wt. %, and Eastman AQ® 55, a polyester available from Eastman Chemical Co., to give 0.95 wt. % of polyester relative to the total weight of the ink. The ratio of copolymer to pigment was 0.7.

Cyan Ink C-4 of the Invention

Cyan Ink C-4 was prepared using the Cyan Pigment Dispersion described above to give 1.4 wt. % of pigment relative to the total weight of the ink. Other additives included diethylene glycol at 12.0 wt. %, Surfynol® 465 at 0.2 wt. % and TruDot™ IJ-4655 at 1.2 wt. %. The ratio of copolymer to pigment was 0.9.

Magenta Ink M-1 of the Invention

Magenta Ink M-1 was prepared using the Magenta Pigment Dispersion described above to give 2.1 wt. % of pigment relative to the total weight of the ink. Other additives included diethylene glycol at 4.5 wt. %, glycerol at 3 wt. %, ethylene glycol butyl ether (Dowanol® EB from Dow Chemical Co.) at 2.5 wt. %, Surfynol® 465 (Air Products and Chemicals, Inc.) at 0.2 wt. %, and Joncryl® 70 at 1.5 wt. % relative to the total weight of the ink. The ratio of copolymer to pigment was 0.7.

Magenta Ink M-2 of the Invention

Magenta Ink M-2 was prepared the same as Magenta Ink M-1 except that TruDot™ IJ-4655 was used instead of Joncryl® 70.

Magenta Ink M-3 of the Invention

Magenta Ink M-3 was prepared using the Magenta Pigment Dispersion described above to give 2.1 wt. % of pigment relative to the total weight of the ink. Other additives included diethylene glycol at 9.0 wt. %, glycerol at 6.0 wt. %, ethylene glycol butyl ether at 2.5 wt. %, Silwet® L-77 (Witco Corp.) at 1.0 wt. %, and Eastman AQ® 55 at 1.5 wt. % of polyester relative to the total weight of the ink. The ratio of copolymer to pigment was 0.7.

Magenta Ink M-4 of the Invention

Magenta Ink M-4 was prepared using the Magenta Pigment Dispersion described above at 2.1 wt. % of pigment relative to the total weight of the ink. Other additives included diethylene glycol at 10.0 wt. %, Surfynol® 465 at 0.2 wt. % and TruDot™ IJ-4655 at 1.96 wt. %. The ratio of copolymer to pigment was 0.9.

Yellow Ink Y-1 of the Invention

Yellow Ink Y-1 was prepared the same as Magenta Ink M-1 except that the Yellow Pigment Dispersion was used instead of the Magenta Pigment Dispersion.

Yellow Ink Y-2 of the Invention

Yellow Ink Y-2 was prepared the same as Magenta Ink M-2 except that the Yellow Pigment Dispersion was used instead of the Magenta Pigment Dispersion.

Yellow Ink Y-3 of the Invention

Yellow Ink Y-3 was prepared the same as Magenta Ink M-3 except that the Yellow Pigment Dispersion was used instead of the Magenta Pigment Dispersion.

Yellow Ink Y-4 of the Invention

Yellow Ink Y-4 was prepared the same as Magenta Ink M-4 except that the Yellow Pigment Dispersion was used instead of the Magenta Pigment Dispersion.

Yellow Ink Y-5 of the Invention

Yellow Ink Y-5 was prepared the same as Yellow Ink Y-1 except that Joncryl® 70 was used at 1.0 wt. %. The ratio of copolymer to pigment was 0.5.

Yellow Ink Y-6 of the Invention

Yellow Ink Y-6 was prepared the same as Yellow Ink Y-2 except that TruDot™ IJ-4655 was used at 1.0 wt. %. The ratio of copolymer to pigment was 0.5.

Yellow Ink Y-7 of the Invention

Yellow Ink Y-7 was prepared the same as Yellow Ink Y-3 except that diethylene glycol was used at 7.0 wt. % and Eastman AQ® 55 was used at 1.0 wt. %. The ratio of copolymer to pigment was 0.5.

Comparative Cyan Ink CC-1 (Commercially Available Ink)

Comparative Cyan Ink CC-1 was the cyan pigment-based ink available as Encad Graphic Outdoor™ (GO) Inks from Encad, Inc. The catalogue number was 210504-00.

Comparative Cyan Ink CC-2 (Commercially Available Ink)

Comparative Cyan Ink CC-2 was the cyan pigment-based ink available for use with the Epson Stylus Photo 2000P from Epson, Inc. The cyan ink was taken from the tri-color cartridge with catalogue number T106201.

Comparative Cyan Ink CC-3 (Commercially Available Ink)

Comparative Cyan Ink CC-3 was the cyan pigment-based ink available for use with the Epson Stylus C80 from Epson, Inc. The catalogue number was T032220.

Comparative Cyan Ink CC-4 (Commercially Available Ink)

Comparative Cyan Ink CC-4 was the cyan pigment-based ink available as Hewlett-Packard 5000 UV Inks from Hewlett-Packard Co. The catalogue number was C4941A.

Comparative Cyan Ink CC-5 (No Polymer Addenda)

Comparative Cyan Ink CC-5 was prepared using the Cyan Pigment Dispersion described above to give 1.4 wt. % of pigment relative to the total weight of the ink. Other additives included diethylene glycol at 13.5 wt. %, glycerol at 6.0 wt. %, ethylene glycol butyl ether at 2.5 wt. % and Surfynol® 465 at 0.2 wt. %.

Comparative Cyan Ink CC-6 (Low Ratio of Copolymer to Pigment)

Comparative Cyan Ink CC-6 was prepared using the Cyan Pigment Dispersion described above to give 1.4 wt. % of pigment relative to the total weight of the ink. Other additives included diethylene glycol at 17.0 wt. %, Surfynol® 465 at 0.2 wt. % and TruDot™ IJ-4655 at 0.4 wt. %. The ratio of copolymer to pigment was 0.3.

Comparative Cyan Ink CC-7 (Low Ratio of Copolymer to Pigment)

A polyurethane copolymer dispersion consisting of 25 wt. % of a polyurethane copolymer of neopentyl glycol, bis(hydroxymethyl)propionic acid and bis(cyclohexylmethylene)diisocyanate at 1:2:3 mole ratio was prepared according to the procedure described in U.S. Pat. No. 6,426,167, the disclosure of which is incorporated herein by reference. This copolymer is referred to as Polyurethane NBB.

Comparative Cyan Ink CC-7 was prepared using the Cyan Pigment Dispersion described above to give 1.4 wt. % of pigment relative to the total weight of the ink. Other additives included diethylene glycol at 6.5 wt. %, glycerol at 3 wt. %, ethylene glycol butyl ether at 2.5 wt. %, Surfynol® 465 at 0.2 wt. % and the polyurethane dispersion described above to give 0.7 wt. % of Polyurethane NBB relative to the total weight of the ink. The ratio of copolymer to pigment was 0.5.

Comparative Cyan Ink CC-8 (low ratio of copolymer to pigment)

Comparative Cyan Ink CC-8 was prepared the same as Comparative Cyan Ink CC-7 except that Joncryl® 70 was used instead of the polyurethane copolymer.

Comparative Cyan Ink CC-9 (Low Ratio of Copolymer to Pigment) Comparative Cyan Ink CC-9 was prepared the same as Comparative Cyan Ink CC-7 except that TruDot™ IJ-4655 was used instead of Polyurethane NBB.

Comparative Cyan Ink CC-10 (Low Ratio of Copolymer to Pigment)

Comparative Cyan Ink CC-10 was prepared using the Cyan Pigment Dispersion described above to give 1.4 wt. % of pigment relative to the total weight of the ink. Other additives included diethylene glycol at 9.0 wt. %, glycerol at 6.0 wt. %, ethylene glycol butyl ether at 2.5 wt. %, Silwet® L-77 at 1.0 wt. % and Eastman AQ® 55 at 0.7 wt. % of polyester relative to the total weight of the ink. The ratio of copolymer to pigment was 0.5.

Comparative Cyan Ink CC-11 (Low Ratio of Copolymer to Pigment)

Comparative Cyan Ink CC-11 was prepared using the Cyan Pigment Dispersion described above to give 1.4 wt. % of pigment relative to the total weight of the ink. Other additives included diethylene glycol at 3.5 wt. %, glycerol at 2.0 wt. %, ethylene glycol butyl ether at 2.5 wt. %, Surfynol® 465 at 0.2 wt. % and TruDot™ IJ-4680, a styrene-acrylic copolymer available from MeadWestvaco Corp., at 0.95 wt. %. The ratio of copolymer to pigment was 0.7.

Comparative Magenta Ink CM-1 (Commercially Available Ink)

Comparative Magenta Ink CM-1 was the magenta pigment-based ink available as Encad Graphic Outdoor™ (GO) Inks from Encad, Inc. The catalogue number was 210505-00.

Comparative Magenta Ink CM-2 (Commercially Available Ink)

Comparative Magenta Ink CM-2 was the magenta pigment-based ink available for use with the Epson Stylus Photo 2000P from Epson, Inc. The magenta ink was taken from the tri-color cartridge with catalogue number T106201.

Comparative Magenta Ink CM-3 (Commercially Available Ink)

Comparative Magenta Ink CM-3 was the magenta pigment-based ink available for use with the Epson Stylus C80 from Epson, Inc. The catalogue number was T032320.

Comparative Magenta Ink CM-4 (Commercially Available Ink)

Comparative Magenta Ink CM-4 was the magenta pigment-based ink available as Hewlett-Packard 5000 UV Inks from Hewlett-Packard Co. The catalogue number was C4942A.

Comparative Magenta Ink CM-5 (No Polymer Addenda)

Comparative Magenta Ink CM-5 was prepared using the Magenta Pigment Dispersion described above to give 2.1 wt. % of pigment relative to the total weight of the ink. Other additives included diethylene glycol at 12.0 wt. %, glycerol at 6.0 wt. %, ethylene glycol butyl ether at 2.5 wt. % and Surfynol® 465 at 0.2 wt. %.

Comparative Magenta Ink CM-6 (Low Ratio of Copolymer to Pigment)

Comparative Magenta Ink CM-6 was prepared using the Magenta Pigment Dispersion described above to give 2.1 wt. % of pigment relative to the total weight of the ink. Other additives included diethylene glycol at 15.0 wt. %, Surfynol® 465 at 0.2 wt. % and TruDot™ IJ-4655 at 0.65 wt. %. The ratio of copolymer to pigment was 0.3.

Comparative Magenta Ink CM-7 (Low Ratio of Copolymer to Pigment)

Comparative Magenta Ink CM-7 was prepared the same as Comparative Cyan Ink CC-7 except that the Magenta Pigment Dispersion was used at 2.1 wt. % instead of the Cyan Pigment Dispersion, diethylene glycol was used at 4.5 wt. % and Polyurethane NBB was used at 1.0 wt. %. The ratio of copolymer to pigment was 0.5.

Comparative Magenta Ink CM-8 (Low Ratio of Copolymer to Pigment)

Comparative Magenta Ink CM-8 was prepared the same as Comparative Magenta Ink CM-7 except that Joncryl® 70 was used instead of Polyurethane NBB.

Comparative Magenta Ink CM-9 (Low Ratio of Copolymer to Pigment)

Comparative Magenta Ink CM-9 was prepared the same as Comparative Magenta Ink CM-7 except that TruDot™ IJ-4655 was used instead of Polyurethane NBB.

Comparative Magenta Ink CM-10 (Low Ratio of Copolymer to Pigment)

Comparative Magenta Ink CM-10 was prepared the same as Comparative Cyan Ink CC-10 except that the Magenta Pigment Dispersion was used at 2.1 wt. % instead of the Cyan Pigment Dispersion, diethylene glycol was used at 7.0 wt. % and Eastman AQ® 55 was used at 1.0 wt. %. The ratio of copolymer to pigment was 0.5.

Comparative Magenta Ink CM-11 (Low Ratio of Copolymer to Pigment)

Comparative Magenta Ink CM-11 was prepared using the Magenta Pigment Dispersion described above at 2.1 wt. % of pigment relative to the total weight of the ink. Other additives included diethylene glycol at 3.0 wt. %, glycerol at 1.5 wt. %, ethylene glycol butyl ether at 2.5 wt. %, Surfynol® 465 at 0.2 wt. % and TruDot™ IJ-4680 at 1.5 wt. %. The ratio of copolymer to pigment was 0.7.

Comparative Yellow Ink CY-1 (Commercially Available Ink)

Comparative Yellow Ink CY-1 was the yellow pigment-based ink available as Encad Graphic Outdoor™ (GO) Inks from Encad, Inc. The catalogue number was 210506-00.

Comparative Yellow Ink CY-2 (Commercially Available Ink)

Comparative Yellow Ink CY-2 was the yellow pigment-based ink available for use with the Epson Stylus Photo 2000P from Epson, Inc. The yellow ink was taken from the tri-color cartridge with catalogue number T106201.

Comparative Yellow Ink CY-3 (Commercially Available Ink)

Comparative Yellow Ink CY-3 was the yellow pigment-based ink available for use with the Epson Stylus C80 from Epson, Inc. The catalogue number was T032420.

Comparative Yellow Ink CY-4 (Commercially Available Ink)

Comparative Yellow Ink CY-4 was the yellow pigment-based ink available as Hewlett-Packard 5000 UV Inks from Hewlett-Packard Co. The catalogue number was C4942A.

Comparative Yellow Ink CY-5 (No Polymer Addenda)

Comparative Yellow Ink CY-5 was prepared the same as Comparative Magenta Ink CM-5 except that the Yellow Pigment Dispersion was used instead of the Magenta Pigment Dispersion.

Comparative Yellow Ink CY-6 (Low Ratio of Copolymer to Pigment)

Comparative Yellow Ink CY-6 was prepared the same as Comparative Magenta Ink CM-6 except that the Yellow Pigment Dispersion was used instead of the Magenta Pigment Dispersion.

Comparative Yellow Ink CY-7 (Low Ratio of Copolymer to Pigment)

Comparative Yellow Ink CY-7 was prepared the same as Comparative Magenta Ink CM-7 except that the Yellow Pigment Dispersion was used instead of the Magenta Pigment Dispersion.

Comparative Yellow Ink CY-8 (Low Ratio of Copolymer to Pigment)

Comparative Yellow Ink CY-8 was prepared the same as Comparative Magenta Ink CM-11 except that the Yellow Pigment Dispersion was used instead of the Magenta Pigment Dispersion.

Printing

All of the above inks were printed using a Lexmark Z51 ink jet printer and an empty ink cartridge having catalogue number 12A1990, except for the following: CC-2, CM-2 and CY-2 were printed using an Epson Stylus Photo 2000P printer; CC-3, CM-3 and CY-3 were printed using an Epson Stylus C80 printer; and CC-4, CM-4 and CY-4 were printed using a Hewlett-Packard DesignJet 5000 printer. In all cases, printing was carried out without color management, such that each patch was printed with a single ink.

The test image consisted of eleven density patches, each approximately 7 by 7 mm in size, and created using Adobe® PhotoShop® v4.0 software (Adobe Systems) in the CMYK mode. The densities of the patches increased incrementally to give 0, 10, 20, 30, 40, 50, 60, 70, 80, 90 and 100% ink laydown such that the patch printed at 100% exhibited a density of 1.5 to 2.0. The inks were printed on Kodak Instant-Dry Photographic Glossy Media having catalogue number 8103137. The printed test images were allowed to dry for 24 hours at ambient temperature and humidity.

Evaluation of Test Images

The specular reflectance measurements were obtained using a PR-705 spectroradiometer, a linear photodiode array spectral measurement device available from Photo Research Spectroscan. The light source was an Oriel fiber-optic illuminator 77501 having a correlated color temperature of 6700 K and was projected using a liquid light guide at Θᵢ=45°. The aperture of the detector was 0.5 by 1.5°.

For each patch, the reflected light intensities in watts/sr/m² were measured at 10 nm increments over the wavelength range of 390 to 770 nm. A reference specular reflectance was obtained at Θᵢ=45° and Θᵣ=−45° for a calibrated (NIST) piece of polished black glass. Each reflected light intensity value was divided by the reference reflectance to give the corresponding specular reflectance values. R_{Smax}(Xn), R_{Smin}(Xn) and R_{Smean}(Xn) were determined for each patch, and NΔR_{S}(XI) through NΔR_{S}(X11) determined according to Equation 2. The normalized differential specular reflectance for the ink, NΔR_{S}(X), was determined according to Equation 1. The results are shown in Tables 1-3. NΔR_{S}(X) values that are desirable are: less than 1.25 for NΔR_{S}(C), less than 0.50 for NΔR_{S}(M), and less than 0.30 for NΔR_{S}(Y).

TABLE 1

| | Polymer | Polymer:Pigment | |
|---|---|---|---|
| Ink | Addenda | Ratio | NΔRₛ (C) |
| C-1 | Joncryl ® 70 | 0.7 | 1.15 |
| C-2 | TruDot ™ | 0.7 | 1.21 |
| | IJ-4655 | | |
| C-3 | Eastman | 0.7 | 1.23 |
| | AQ ® 55 | | |
| C-4 | TruDot ™ | 0.9 | 1.12 |
| | IJ-4655 | | |
| CC-1 | unknown | N/A | 1.30 |
| | (Encad GO) | | |
| CC-2 | unknown | N/A | 1.58 |
| | (Epson 2000P) | | |
| CC-3 | unknown | N/A | 1.42 |
| | (Epson C80) | | |
| CC-4 | unknown | N/A | 1.41 |
| | (HP 5000 UV) | | |
| CC-5 | none | N/A | 1.55 |
| CC-6 | TruDot ™ | 0.3 | 1.39 |
| | IJ-4655 | | |
| CC-7 | Polyurethane | 0.5 | 1.36 |
| | NBB | | |
| CC-8 | Joncryl ® 70 | 0.5 | 1.26 |
| CC-9 | TruDot ™ | 0.5 | 1.31 |
| | IJ-4655 | | |
| CC-10 | Eastman | 0.5 | 1.34 |
| | AQ ® 55 | | |
| CC-11 | TruDot ™ | 0.7 | 1.28 |
| | IJ-4680 | | |

TABLE 2

| | Polymer | Polymer:Pigment | |
|---|---|---|---|
| Ink | Addenda | Ratio | NΔRₛ (M) |
| M-1 | Joncryl ® 70 | 0.7 | 0.46 |
| M-2 | TruDot ™ | 0.7 | 0.49 |
| | IJ-4655 | | |
| M-3 | Eastman | 0.7 | 0.49 |
| | AQ ® 55 | | |
| M-4 | TruDot ™ | 0.9 | 0.48 |
| | IJ-4655 | | |
| CM-1 | unknown | N/A | 0.42 |
| CM-2 | unknown | N/A | 0.62 |
| CM-3 | unknown | N/A | 0.56 |
| CM-4 | unknown | N/A | 0.53 |
| CM-5 | none | N/A | 0.66 |
| CM-6 | TruDot ™ | 0.3 | 0.63 |
| | IJ-4655 | | |
| CM-7 | Polyurethane | 0.5 | 0.59 |
| | NBB | | |
| CM-8 | Joncryl ® 70 | 0.5 | 0.51 |
| CM-9 | TruDot ™ | 0.5 | 0.52 |
| | IJ-4655 | | |
| CM-10 | Eastman | 0.5 | 0.56 |
| | AQ ® 55 | | |
| CM-11 | TruDot ™ | 0.7 | 0.50 |
| | IJ-4680 | | |

TABLE 3

| | Polymer | Polymer:Pigment | |
|---|---|---|---|
| Ink | Addenda | Ratio | NΔRₛ (Y) |
| Y-1 | Joncryl ® 70 | 0.7 | 0.28 |
| Y-2 | TruDot ™ | 0.7 | 0.26 |
| | IJ-4655 | | |
| Y-3 | Eastman | 0.7 | 0.23 |
| | AQ ® 55 | | |
| Y-4 | TruDot ™ | 0.9 | 0.22 |
| | IJ-4655 | | |
| Y-5 | Joncryl ® 70 | 0.5 | 0.26 |
| Y-6 | TruDot ™ | 0.5 | 0.28 |
| | IJ-4655 | | |
| Y-7 | Eastman | 0.5 | 0.23 |
| | AQ ® 55 | | |
| CY-1 | unknown | N/A | 0.43 |
| CY-2 | unknown | N/A | 0.38 |
| CY-3 | unknown | N/A | 0.54 |
| CY-4 | unknown | N/A | 0.36 |
| CY-5 | none | N/A | 0.53 |
| CY-6 | TruDot ™ | 0.3 | 0.33 |
| | IJ-4655 | | |
| CY-7 | Polyurethane | 0.5 | 0.42 |
| | NBB | | |
| CY-11 | TruDot ™ | 0.7 | 0.34 |
| | IJ-4680 | | |

The results in Table 1 show that the cyan ink compositions of the present invention each have a maximum normalized differential specular reflectance, NΔR_{S}(C), of less than 1.25. The comparative cyan ink compositions have NΔR_{S}(C) greater than 1.25. The chromatic gloss observed for each of the cyan ink compositions of the present invention is less objectionable than the chromatic gloss observed for the comparative cyan ink compositions.

The results in Table 2 show that the magenta ink compositions of the present invention each have a maximum normalized differential specular reflectance, NΔR_{S}(M), of less than 0.50. The comparative magenta ink compositions have NΔR_{S}(M) values of at least 0.50, except for CM-1. The patches printed using CM-1 had very low, unappealing gloss for which the normalization carried out in Equation 2 could not completely compensate. As a result, NΔR_{S}(M) for ink CM-1 was anomalously low. The chromatic gloss observed for each of the magenta ink compositions of the present invention is less objectionable than the chromatic gloss observed for the comparative magenta ink compositions.

The results in Table 3 show that the yellow ink compositions of the present invention each have a normalized differential specular reflectance, NΔR_{S}(Y), of less than 0.30. The comparative yellow ink compositions have NΔR_{S}(Y) greater than 0.30. The chromatic gloss observed for each of the yellow ink compositions of the present invention is less objectionable than the chromatic gloss observed for the comparative yellow ink compositions.

The present invention shows that the normalized differential specular reflectance for a given ink composition can be minimized by the addition of polymer addenda. In general, NΔR_{S}(X) decreases as the pigment to polymer ratio increases, and the amount of polymer necessary in the ink composition depends upon the particular polymer and the various other components which are present in the ink composition.

The polymers employed in the invention had similar effects on NΔR_{S}(C) and NΔR_{S}(M). For the cyan ink compositions, most of the polymers minimized NΔR_{S}(C) to less than 1.25 when used at a polymer to pigment ratio of 0.7; TruDot™ IJ-4680 was the only exception. For the magenta ink compositions, TruDot™ IJ-4680 was again the only exception; all of the other polymers minimized NΔR_{S}(M) to less than 0.50. NΔR_{S}(Y) for the yellow ink compositions required the least amount of polymer in order to lower NΔR_{S}(Y) to an acceptable level. Joncryl® 70, TruDot™ IJ-4655 and Eastman AQ® 55 each gave NΔR_{S}(Y) of less than 0.30 when used at a polymer to pigment ratio of 0.5, which is lower than the ratio of 0.7 required for the cyan and magenta ink compositions.

The present description will be directed in particular to elements forming part of, or cooperating more directly with, apparatus and methods in accordance with the present invention. It is to be understood that elements not specifically shown or described may take various forms well known to those skilled in the art.

What is claimed is:

1. A cyan pigment-based ink composition for ink jet printing, the ink composition comprising a cyan pigment, water, water miscible humectants and/or water-miscible organic co-solvents, optional surfactants, or mixtures thereof; wherein the ink composition has a normalized differential specular reflectance, NΔR_{S}(C), of less than 1.25 when calculated according to Equation 1:
NΔR_{S}(C)=[NΔR_{S}(Cn)]ₘₐₓ Equation 1
where C represents the cyan ink composition, n is an integer associated with each density patch printed as part of a test image, and [NΔR_{S}(Cn)] max is the maximum value of the normalized differential specular reflectances that are calculated for the density patches printed using the cyan ink composition; wherein the image-recording element has a gloss value of at least 5 when measured at 60; wherein the test image for the cyan ink composition consists of a series of at least ten density patches printed such that the ink laydown on the patches increases incrementally, from no ink laydown to a maximum level generating a density of at least 1.5; and wherein the normalized differential specular reflectance value for each patch, NΔR_{S}(Cn), is determined according to Equation 2:
$$N Δ {R}_{S} ( C n ) = \frac{[ {R}_{S max} ( C n ) - {R}_{S min} ( C n ) ]}{{R}_{S mean} ( C n )} \qquad Equation 2$$
where R_{Smax}(Cn) is the maximum specular reflectance over the visible spectral region between 390 nm and 720 nm for patch Cn, R_{Smin}(Cn) is the minimum specular reflectance over the visible spectral region between 390 nm and 720 nm for patch Cn, and R_{Smean}(Cn) is the average specular reflectance over the visible spectral region between 390 nm and 720 nm for patch Cn.

2. The ink composition according to claim 1, wherein said cyan pigment comprises a pigment selected from the group consisting of Pigment Blue 15:2, Pigment Blue 15:3, Pigment Blue 15:4, Pigment Blue 60, and bis(phthalocyanylalumino)tetraphenyldisiloxane.

3. The ink composition according to claim 1, wherein said cyan pigment has a median particle size of less than 0.3 μm.

4. The ink composition according to claim 1, wherein said cyan pigment has a median particle size of less than 0.15 μm.

5. The ink composition according to claim 1, wherein said cyan pigment is a composite colorant particle.

6. The ink composition according to claim 1, wherein said cyan pigment is dispersed with a polymer.

7. The ink composition according to claim 1, wherein said cyan pigment is dispersed with an amphiphile.

8. The ink composition according to claim 1, wherein said cyan pigment is dispersed with an inorganic salt of N-methyl-N-oleoyl taurate.

9. The ink composition according to claim 1 further comprising particles.

10. The ink composition according to claim 1, further comprising silica, alumina, titanium dioxide, zircona, clay, calcium carbonate, barium sulfate, zinc oxide, polymeric particles, or mixtures thereof.

11. The ink composition according to claim 1, further comprising a water soluble polymer, a water reducible polymer or a water dispersible polymer.

12. The ink composition according to claim 11, wherein said water soluble polymer, said water reducible polymer, said water dispersible polymer, or said mixtures thereof is present in an amount necessary to give a normalized differential specular reflectance for said ink composition, NΔR_{S}(C), of less than 1.25.

13. The ink composition according to claim 11, further comprising an addition polymer or a condensation polymer.

14. The ink composition according to claim 11, further comprising an addition polymer prepared from acrylic and/or styrenic monomers, a polyester, or a polyurethane.

15. The ink composition according to claim 14, wherein said acrylic monomer comprises a derivative of acrylic acid, an acrylate ester, an acrylamide, or an unsaturated anhydride or unsaturated imide monomer.

16. The ink composition according to claim 15, wherein said unsaturated anhydride or unsaturated imide monomer may be completely or partially hydrolyzed after polymerization to form the corresponding carboxylic acid or amide functionality.

17. The ink composition according to claim 14, wherein said styrenic monomer comprises a derivative of styrene, an α-alkylstyrene, a trans-β-alkylstyrene, an alkylstyrene, an alkoxystyrene, a halogenated styrene, or a vinyl naphthalene.

18. The ink composition according to claim 14, wherein said polyester is derived from isophthalic acid, sodium sulfoisophthalic acid, diethylene glycol, and 1,4-cyclohexanedimethanol.

19. The ink composition according to claim 1, further comprising a non-volatile organic compound which does not penetrate the surface of the recording element.

20. The ink composition according to claim 19, wherein said non-volatile organic compound is present in an amount necessary to give a normalized differential specular reflectance for said ink composition, NΔR_{S}(C), of less than 1.25.

21. The ink composition according to claim 19, wherein said non-volatile organic compound is a glycol-containing oligomer.

22. The ink composition according to claim 11, wherein the ratio of addition polymer or condensation polymer to cyan pigment is at least 0.3.

23. The ink composition according to claim 11, wherein the ratio of addition polymer or condensation polymer to cyan pigment is at least 0.5.

24. The ink composition according to claim 1, wherein NΔR_{S}(C), is less than 1.15 when calculated according to Equation 1.

25. A magenta pigment-based ink composition for ink jet printing, the ink composition comprising a magenta pigment, water, water miscible humectants and/or water-miscible organic co-solvents, optional surfactants, or mixtures thereof; wherein the ink composition has a normalized differential specular reflectance, NΔR_{S}(M), of less than 0.50 when calculated according to Equation 1:
NΔR_{S}(M)=[NΔR_{S}(Mn)]ₘₐₓ Equation 1
where M represents the magenta ink composition, n is an integer associated with each density patch printed as part of a test image, and [NΔR_{S}(Mn)]ₘₐₓ is the maximum value of the normalized differential specular reflectances that are calculated for the density patches printed using the magenta ink composition; wherein the image-recording element has a gloss value of at least 5 when measured at 60°; wherein the test image for the magenta ink composition consists of a series of at least ten density patches printed such that the ink laydown on the patches increases incrementally, from no ink laydown to a maximum level generating a density of at least 1.5; and wherein the normalized differential specular reflectance value for each patch, NΔR_{S}(Mn), is determined according to Equation 2:
$$N Δ {R}_{S} ( M n ) = \frac{[ {R}_{S max} ( M n ) - {R}_{S min} ( M n ) ]}{{R}_{S mean} ( M n )} \qquad Equation 2$$
where R_{Smax}(Mn) is the maximum specular reflectance over the visible spectral region between 390 nm and 720 nm for patch Mn, R_{Smin}(Mn) is the minimum specular reflectance over the visible spectral region between 390 nm and 720 nm for patch Mn, and R_{Smean}(Mn) is the average specular reflectance over the visible spectral region between 390 nm and 720 nm for patch Mn.

26. The ink composition according to claim 25, wherein said magenta pigment comprises a pigment selected from the group consisting of Pigment Red 122, Pigment Red 57:1, Pigment Red 123, Pigment Red 168, Pigment Red 184, Pigment Red 202 or Pigment Red 207.

27. The ink composition according to claim 25, wherein said magenta pigment has a median particle size of less than 0.3 μm.

28. The ink composition according to claim 25, wherein said magenta pigment has a median particle size of less than 0.15 μm.

29. The ink composition according to claim 25, wherein said magenta pigment is a composite colorant particle.

30. The ink composition according to claim 25, wherein said magenta pigment is dispersed with a polymer.

31. The ink composition according to claim 25, wherein said magenta pigment is dispersed with an amphiphile.

32. The ink composition according to claim 25, wherein said magenta pigment is dispersed with an inorganic salt of N-methyl-N-oleoyl taurate.

33. The ink composition according to claim 25 further comprising particles.

34. The ink composition according to claim 25, further comprising silica, alumina, titanium dioxide, zircona, clay, calcium carbonate, barium sulfate, zinc oxide, polymeric particles, or mixtures thereof.

35. The ink composition according to claim 25, further comprising a water soluble polymer, a water reducible polymer or a water dispersible polymer, or mixtures thereof.

36. The ink composition according to claim 35, wherein said water soluble polymer, said water reducible polymer, said water dispersible polymer, or said mixtures thereof is present in an amount necessary to give a normalized differential specular reflectance for said ink composition, NΔR_{S}(M), of less than 0.50.

37. The ink composition according to claim 35, further comprising an addition polymer or a condensation polymer.

38. The ink composition according to claim 35, further comprising an addition polymer prepared from acrylic and/or styrenic monomers, a polyester, or a polyurethane.

39. The ink composition according to claim 38, wherein said acrylic monomer comprises a derivative of acrylic acid, an acrylate ester, an acrylamide, or an unsaturated anhydride or unsaturated imide monomer.

40. The ink composition according to claim 39, wherein said unsaturated anhydride or unsaturated imide monomer may be completely or partially hydrolyzed after polymerization to form the corresponding carboxylic acid or amide functionality.

41. The ink composition according to claim 38, wherein said styrenic monomer comprises a derivative of styrene, an α-alkylstyrene, a trans-β-alkylstyrene, an alkylstyrene, an alkoxystyrene, a halogenated styrene, or a vinyl naphthalene.

42. The ink composition according to claim 38, wherein said polyester is derived from isophthalic acid, sodium sulfoisophthalic acid, diethylene glycol, and 1,4-cyclohexanedimethanol.

43. The ink composition according to claim 25, further comprising a non-volatile organic compound which does not penetrate the surface of the recording element.

44. The ink composition according to claim 43, wherein said non-volatile organic compound is present in an amount necessary to give a normalized differential specular reflectance for said ink composition, NΔR_{S}(M), of less than 0.50.

45. The ink composition according to claim 43, wherein said non-volatile organic compound is a glycol-containing oligomer.

46. The ink composition according to claim 37, wherein the ratio of said addition polymer, said condensation polymer or said mixtures thereof to said magenta pigment is at least 0.3.

47. The ink composition according to claim 37, wherein the ratio of said addition polymer, said condensation polymer or said mixtures thereof to said magenta pigment is at least 0.5.

48. A yellow pigment-based ink composition for ink jet printing, the ink composition comprising a yellow pigment, water, water miscible humectants and/or water-miscible organic co-solvents, optional surfactants, or mixtures thereof; wherein the ink composition has a normalized differential specular reflectance, NΔR_{S}(Y), of less than 0.30 when calculated according to Equation 1:
NΔR_{S}(Y)=[NΔR_{S}(Yn)]ₘₐₓ Equation 1
where Y represents the yellow ink composition, n is an integer associated with each density patch printed as part of a test image, and [NΔR_{S}(Yn)]ₘₐₓ is the maximum value of the normalized differential specular reflectances that are calculated for the density patches printed using the yellow ink composition; wherein the image-recording element has a gloss value of at least 5 when measured at 60°; wherein the test image for the yellow ink composition consists of a series of at least ten density patches printed such that the ink laydown on the patches increases incrementally, from no ink laydown to a maximum level generating a density of at least 1.5; and wherein the normalized differential specular reflectance value for each patch, NΔR_{S}(Yn), is determined according to Equation 2:
$$N Δ {R}_{S} ( Y n ) = \frac{[ {R}_{S max} ( Y n ) - {R}_{S min} ( Y n ) ]}{{R}_{S mean} ( Y n )} \qquad Equation 2$$
where R_{Smax}(Yn) is the maximum specular reflectance over the visible spectral region between 390 nm and 720 nm for patch Yn, R_{Smin}(Yn) is the minimum specular reflectance over the visible spectral region between 390 nm and 720 nm for patch Yn, and R_{Smean}(Yn) is the average specular reflectance over the visible spectral region between 390 nm and 720 nm for patch Yn.

49. The ink composition according to claim 48, wherein said yellow pigment comprises a pigment selected from the group consisting of Pigment Yellow 155, Pigment Yellow 74, Pigment Yellow 128, Pigment Yellow 13 or Pigment Yellow 93.

50. The ink composition according to claim 48, wherein said yellow pigment has a median particle size of less than 0.3 μM.

51. The ink composition according to claim 48, wherein said yellow pigment has a median particle size of less than 0.15 μm.

52. The ink composition according to claim 48, wherein said yellow pigment is a composite colorant particle.

53. The ink composition according to claim 48, wherein said yellow pigment is dispersed with a polymer.

54. The ink composition according to claim 48, wherein said yellow pigment is dispersed with an amphiphile.

55. The ink composition according to claim 48, wherein said yellow pigment is dispersed with an inorganic salt of N-methyl-N-oleoyl taurate.

56. The ink composition according to claim 48 further comprising particles.

57. The ink composition according to claim 48, further comprising silica, alumina, titanium dioxide, zircona, clay, calcium carbonate, barium sulfate, zinc oxide, polymeric particles, or mixtures thereof.

58. The ink composition according to claim 48, further comprising a water soluble polymer, a water reducible polymer or a water dispersible polymer;

59. The ink composition according to claim 58, wherein said water soluble polymer, said water reducible polymer, said water dispersible polymer, or said mixtures thereof is present in an amount necessary to give a normalized differential specular reflectance for said ink composition, NΔR_{S}(Y), of less than 0.30.

60. The ink composition according to claim 58, further comprising an addition polymer or a condensation polymer.

61. The ink composition according to claim 58, further comprising an addition polymer prepared from acrylic and/or styrenic monomers, a polyester, or a polyurethane.

62. The ink composition according to claim 61, wherein said acrylic monomer comprises a derivative of acrylic acid, an acrylate ester, an acrylamide, or an unsaturated anhydride or unsaturated imide monomer;

63. The ink composition according to claim 62, wherein said unsaturated anhydride or unsaturated imide monomer may be completely or partially hydrolyzed after polymerization to form the corresponding carboxylic acid or amide functionality.

64. The ink composition according to claim 61, wherein said styrenic monomer comprises a derivative of styrene, an α-alkylstyrene, a trans-β-alkylstyrene, an alkylstyrene, an alkoxystyrene, a halogenated styrene, or a vinyl naphthalene.

65. The ink composition according to claim 61, wherein said polyester is derived from isophthalic acid, sodium sulfoisophthalic acid, diethylene glycol, and 1,4-cyclohexanedimethanol.

66. The ink composition according to claim 48, further comprising a non-volatile organic compound which does not penetrate the surface of the recording element.

67. The ink composition according to claim 66, wherein said non-volatile organic compound is present in an amount necessary to give a normalized differential specular reflectance for said ink composition, NΔR_{S}(Y), of less than 0.30.

68. The ink composition according to claim 66, wherein said non-volatile organic compound is a glycol-containing oligomer.

69. The ink composition according to claim 60, wherein the ratio of addition polymer, condensation polymer or mixtures thereof to yellow pigment is at least 0.3.

70. The ink composition according to claim 60, wherein the ratio of addition polymer, condensation polymer or mixtures thereof to yellow pigment is at least 0.5.
